(19) United States
(12) Patent Application Publication
(10) Pub. No.: US 2002/0145573 A1
(43) Pub. Date: Oct. 10, 2002

(54) Compact portable virtual image display

(75) Inventor: Bruce C.H. Cheng, Taipei (TW)

Correspondence Address: Bo-In Lin, 13445 Mandoli Drive, Los Altos Hills, CA, 94022, US

(73) Assignee: Delta Electronics, Inc.

(21) Appl. No.: 10/118,560

(22) Filed: Apr. 8, 2002

Related U.S. Application Data
(60) Provisional application No. 60/282,044, filed on Apr. 7, 2001.

(51) Int. Cl. G09G 5/00

(52) U.S. Cl. 345/7

(57) ABSTRACT

This invention discloses a portable electronic device. The portable electronic device has an image source. The portable electronic device further includes a virtual image display system for display a virtual image. The virtual image display system further includes a real image means for generating a real image for the image source. The virtual image display system further includes a virtual image means for generating a magnified virtual image of the real image.

This Application is a Formal Application claims a Priority Date of Apr. 7, 2001, benefited from a previously filed Provisional Application 60/282,044 by the same Applicant of this Application.

### FIELD OF THE INVENTION

The present invention relates generally to the image display systems. More particularly, this invention relates to a low cost compact virtual image display system suitable for implementation on a portable device.

### BACKGROUND OF THE INVENTION

Current state of the arts in making color image display for the portable devices are confronted with several technical challenges. The first limitation is a comparatively low quality of the image display due to the low resolution commonly provided by the image display devices currently available Further limitations arise from the portability requirements that the display system must be designed with reduced size and weight. The design parameters such as range of operation voltages, rate of power consumption and heat dissipation, and all related design considerations, which must be factored into the miniaturized devices, lead to very limited design and configuration options. Due to these limitations, improvement of display resolution cannot be easily achieved. Higher production cost of color display by applying different technologies as will be discussed below also restricts a broader application and availability of the portable color display devices.

For portable color image display, the technology of TFT LCD is commonly used to provide a panel display for a dimension of 6.4″ or lower, measured across the length of the panel diagonal. The TFT LCD panel display is limited by a resolution of 320×320 pixels per square inch categorized as QVGA display. Another technology of applying STN LCD display, under the restriction of reduced size and weight to achieve portability, is also limited by low image display quality due to low resolution. The technology of field-emission display (FED) is limited in its application for portable devices due to a higher driving voltage for phosphors. An emerging technology of employing polymer light emitting display is promising but is currently under development and would not be immediately applicable to resolve the difficulties and limitations faced by those of ordinary skill in the art.

A virtual image viewer is now available that uses a small imager and then magnify a small image to provide a large size image to a single eye. Using this technology, a virtual image viewer of relatively light and small size can be made available to display a color full-page image. However, the usefulness of such devices is limited by the human reactions when looking at images with a single-eye image viewer. Single eye viewing causes a feeling of discomfort and heightened metal stress lessens the practical usefulness of commonly available virtual image viewer, particularly application for miniaturized pocket size electronic devices such as a personal digital assistant (PDA).

Lebby et. al disclose in U.S. Pat. No. 6,029,073, entitled “Display Carrier with Binocular View for a Portable Electronic Device”, a display carrier with virtual image apparatus for binocular viewing attached to a portable electronic device. A portable electronic device including a display carrier detachably mounted to the portable electronic device. The display carrier including a virtual image display apparatus. A data communication interface is provided between the display carrier and the portable electronic device for permitting data exchange between the display apparatus and the portable electronic device. The display apparatus including a binocular optical system for providing an image output at a right eye output and a left eye output. Referring now to FIGS. 1A, 1B, and 1C for simplified schematic views of plurality of binocular optical systems, which can be utilized in virtual display apparatus of the Lebby's disclosure. The virtual display is designed to have a multiple magnification levels. Typically, magnification levels of 5 and 15 are provided in Lebby's systems. Illustrated in FIG. 1A is a first binocular optical system 50, including two discrete optical systems, which may be included as a part of display apparatus. Optical system 50 includes dual image sources 52 and 53, mounted to a tab tape 51. Image sources 52 and 53 are mounted a distance “d1” of approximately 50 mm or less to achieve binocular viewing. Lens systems 54 and 55 are included for magnification of the image received from image sources 52 and 53. During operation one video signal is received at an input 56 and submitted to both image sources 52 and 53. This type of system, with the submission of one video signal creates a binocular, non-stereoscopic system. Illustrated in FIG. 1B is a second binocular optical system 60. Optical system 60 includes one image source 62. During operation the image generated by image source 62 passes through a first optical element 62. A fifty percent (50%) beamsplitter 66 is positioned in a path of the generated image, therefore splitting the image into a dual optical path. A first portion 63 of the generated image is split and ultimately reflected off the surface of a 100% reflective mirror 68 and ultimately passes through an optical element 70 and is output as a right eye output 72. A second portion 67 of the generated image passes through beamsplitter 66 and is reflected off the surfaces of 100% reflective mirrors 74 and 76 prior to passing through an optical element 78 and is output as a left eye output 79. This type of dual optical path system creates a binocular, non-stereoscopic system. Again, a separation distance “d2” is approximated at 50 mm or less between right eye output 72 and left eye output 79 to create binocular viewing. Illustrated in FIG. 1C is a third binocular optical system 80 which is generally composed of two image sources 82 and 84 and two discrete optical systems. Image sources 82 and 84 are typically formed of a liquid crystal display 85 and 86 and backlights 87 and 88. The optical systems are composed of optical elements 90 and 92 with a right eye output 93 and a left eye output 94. During operation two discrete video signals 100 and 102 are received at an input. This system utilizes the two video signals 100 and 102 to create left/right eye pair video images for creating a binocular, stereoscopic three-dimensional (3D) system. As illustrated, left eye optical system includes a second optical element 91 so as to allow for different magnification levels to be used. In this embodiment, the left eye optical system would be switched into a low magnification mode with moveable or changeable optical element 91. When lens 91 is utilized instead of lens 90, a low magnification mode would allow for the viewing of a direct view type image. This low magnification image can be viewed from 10-15 inches away. When optical elements 90 and 92 are used, a binocular viewing, high magnification mode would allow for the viewing of a virtual image.

Lebby's display system as shown in FIGS. 1A to 1C that implements display apparatus using multiple sets of image sources, optical lenses and LCD display images. The size and weight of the display system is increased and the cost for manufacturing such display system is also more expensive because of more optical components and image sources employed in the system.

As the portable electronic devices become more widespread, the demand for a page size, high-resolution color image display is also increased. In additional to portable electronic devices, more manufacture facilities and equipment control are now handled by electronic and computer control panels that require man-machine interface with page size image displays. In view of these rapidly increasing demands, for those of ordinary skill in the art of portable image display, a great challenge and urgency exists to improve current monochromatic low-resolution image display systems. Particularly, for portable devices, a compact, full color, high resolution and low cost image display device for comfortable viewing by human eyes are necessary to satisfy such demands for image display improvement.

### SUMMARY OF THE PRESENT INVENTION

It is therefore an object of the present invention to provide an improved design and configuration for manufacturing and assembling a binocular virtual image display system with miniaturized size and weight while providing high resolution full color display to overcome the aforementioned difficulties and limitations in the prior art.

Specifically, it is an object of the present invention to provide an improved design and configuration for manufacturing and assembling a binocular virtual image display system for a portable electronic device by first generating a real image. The real image is then projected to a virtual image system to produce a binocular virtual image. The virtual image system can be made with reduced size by taking advantages of flexibly adjusting the size and positions of the real image as derived image source.

Another object of the present invention is to provide an improved design and configuration for manufacturing and assembling a binocular virtual image display system for a portable electronic device wherein the virtual image source is provided with a foldable configuration. The portable electronic device can have a reduced thickness when folded thus becomes more convenient for portable as a pocket-sized device.

Briefly, in a preferred embodiment, the present invention includes a portable electronic device. The portable electronic device has an image source. The portable electronic device further includes a virtual image display system for display a virtual image. The virtual image display system further includes a real image means for generating a real image for the image source. The virtual image display system further includes a virtual image means for generating a magnified virtual image of the real image. In a preferred embodiment, the virtual image display system further includes a foldable means for folding the virtual image display system for reducing a thickness of the portable electronic device. In another preferred embodiment, the virtual image display system further includes a beam splitter and concave reflector for generating the virtual image. In yet another preferred embodiment, the virtual image display system further includes a viewing means for allowing a both-eye-viewing window for symmetrically looking at the virtual image generated from the image source. In yet another preferred embodiment, the real image means further includes a set of real image lenses for generating a real image from the image source. In yet another preferred embodiment, the image source further includes a sequential color image source and a micro-display device for generating an image for the portable electronic device. In yet another preferred embodiment, the virtual image display system having a dimension of approximately three to five inches in height and one to three inches in thickness.

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

FIGS. 1A to 1C are side cross sectional views of virtual image display system of a prior art patent;

FIG. 2 is a side cross sectional view of a virtual image display system of this invention;

FIG. 3 is a side cross sectional view showing the height and depth of the display system of FIG. 2; and

FIGS. 4A and 4B are two side cross sectional views of a virtual display system before and after folded with a foldable mechanism to reduce the thickness of the virtual display system.

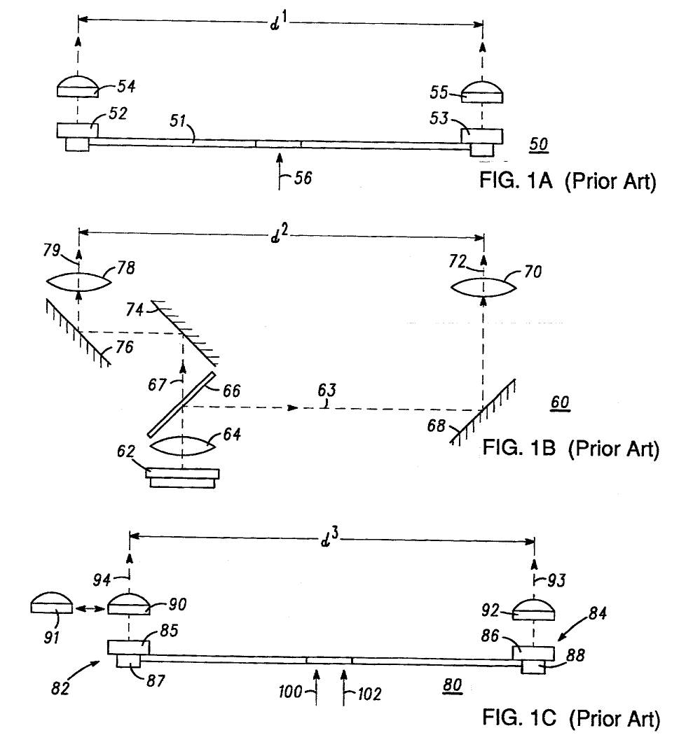

### DETAILED DESCRIPTION OF THE INVENTION

Referring to FIG. 2 for a side cross sectional view for showing a configuration and the optical path of a virtual image display system of the present invention. The virtual image display system includes an image source 110 that may be a color sequential light source projecting a color sequential image light through a micro-display system 120. The micro-display system is a reflective image source, e.g., an image source mirror 120. The image source 110 is has short response time and high-resolution display and packaged in a small and portable device. An exemplary image source is a reflective liquid crystal on silicon (LCOS) imager that is 0.4 to 0.5 inches in diagonal with 800×600 resolution and has a response time of 180 Hz field rate of higher. A RGB sequential light source with relatively collimated light output is employed to illuminate the image source 110. The individual color outputs are synchronized with the data/video images on the LCOS. The illuminating light source could be a RGE LED cluster or a set of color light panels with fast sequential response. One example the illuminating light source could be a light panel with RGB output illuminated with high-brightness fluorescent. Because of the small size, such color image source can be produced with low cost and low power and yet can achieve high-resolution color image display in a very small area. For the purpose of viewing by a user of the portable electronic device, e.g. user of a PDA or a control display panel, the colored light is modulated by the reflective image source 120. The modulated color lights are then collected and projected through a beam splitter 125, a first mirror 130, a first set of lenses 135, a second mirror 140 and a second set of mirrors 145. An intermediate real image 150 is generated. This intermediate image can be flexibly adjusted to have different kinds of magnification for displaying a virtual image with reduced distortions and improved resolution to achieve high quality display for portable electronic device.

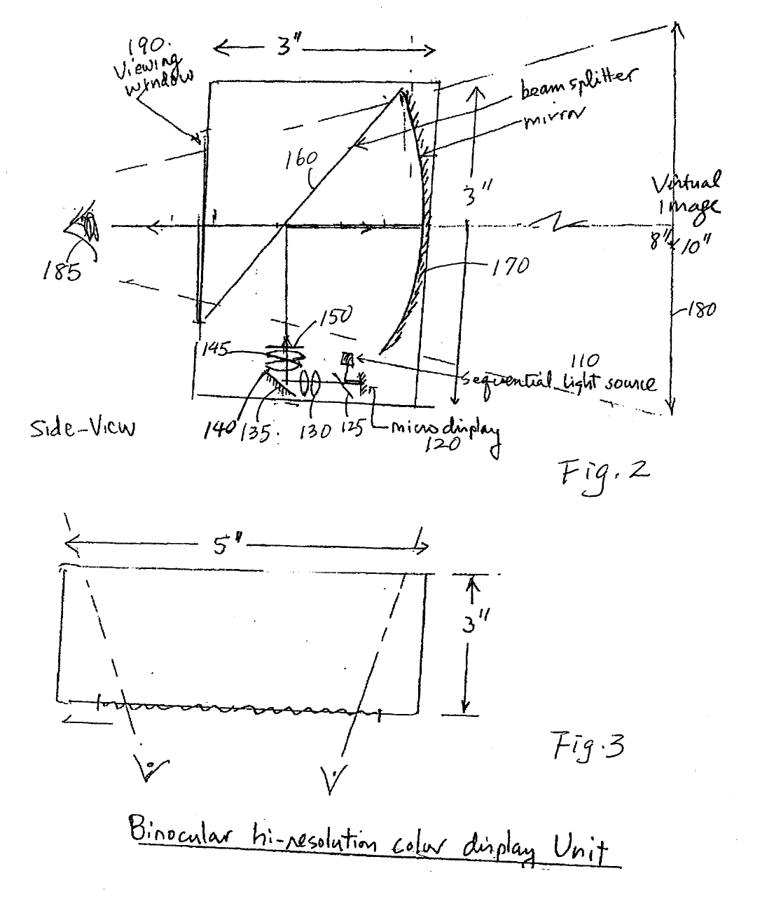

The intermediate real image 150 is then projected onto a beam splitter 160 for projecting the color image light to a concave mirror 170. A virtual image 180 is generated for a user 185 looking onto the mirror via a viewing window 190. In a preferred embodiment, the size of the concave mirror 170 is about 3 inches. AS that shown in FIG. 3, the user 185 is looking at the virtual image 180 at a comfortable distance from both eyes, as the virtual image is now a magnified image from the intermediate real image 150. The view optics including the beam splitter 160 and the concave mirror 170 are arranged to have a slightly tilted on-axis mirror/reflection optical configuration for the magnification and the projection of the virtual image. The small tilted angle of three to seven degrees to allow a more comfortable viewing.

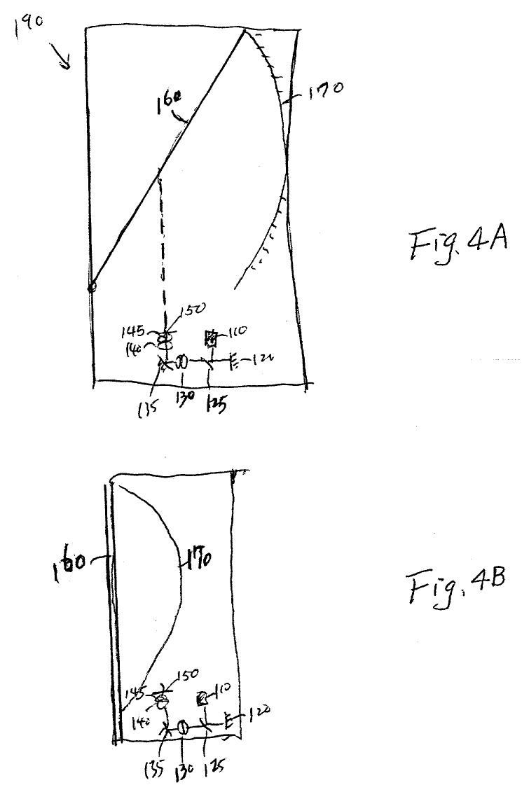

In a preferred embodiment, an image source employs a 0.45 inch LCOS monochrome panel with a SVGA resolution and the light source is a high brightness light emitting diode (LED) array with RGB color LED elements. The LED array is driven to provide sequential color RGB light to illuminate the reflective LCOS imager. The illumination is a beam splitter arrangement for an on-axis configuration. Lens surface is also added to correct the disparity due to the reflection and magnifying mirror element. With such design, a page-size virtual-image 180 is provided to the user 185 at a distance of about 12 to 15 inches in front of the eyes. With such a virtual display system, a lightweight and small size display can be arranged for a dimension of approximately three inches high, five inches wide and three inches deep. The beam splitter 160 and the concave mirror170 can be conveniently arranged to have a foldable configuration with an extended and a foldable configuration with a foldable mechanism as that shown in FIGS. 4A and 4B. The display system can be folded into a thinner pocket size unit that can be very conveniently carried in a regular sized pocket.

According to above descriptions and FIGS. 2 to 4b, this invention discloses a portable electronic device having an image source. The portable electronic device further comprises a virtual image display system for display a virtual image. The virtual image display system further includes a real image means for generating a real image for the image source. The virtual image display system further comprising a virtual image means for generating a magnified virtual image of the real image. In a preferred embodiment, the virtual image display system further includes a foldable means for folding the virtual image display system for reducing a thickness of the portable electronic device. In another preferred embodiment, the virtual image display system further includes a beam splitter and concave reflector for generating the virtual image. In another preferred embodiment, the virtual image display system further includes a viewing means for allowing a both-eye viewing window for symmetrically looking at the virtual image generated from the image source. In another preferred embodiment, the real image means further includes a set of real image lenses 140 and 145 for generating a real image from the image source. In another preferred embodiment, the image source further includes a color sequential light source and a micro-display device for generating an image for the portable electronic device. In another preferred embodiment, the virtual image display system having a dimension of approximately three to five inches in height and one to three inches in thickness.

In a preferred embodiment, this invention further discloses a method for configuring an image display for a portable electronic device. The method includes steps of employing a real image means for generating a real image of an image source. And, the method further includes a step of employing a virtual image means for generating a magnified virtual image of the real image. In a preferred embodiment, the method further includes a step of configuring the virtual image means as a foldable virtual image display system for folding the virtual image display for reducing a thickness of the portable electronic device.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A portable electronic device having an image source further comprising:
a virtual image display system for display a virtual image;
said virtual image display system further includes a real image means for generating a real image for said image source; and
said virtual image display system further comprising a virtual image means for generating a magnified virtual image of said real image.

2. The portable electronic device of claim 1 wherein:
said virtual image display system further includes a foldable means for folding said virtual image display system for reducing a thickness of said portable electronic device.

3. The portable electronic device of claim 1 wherein:
said virtual image display system further includes a beam splitter and concave reflector for generating said virtual image.

4. The portable electronic device of claim 1 wherein:
said virtual image display system further includes a viewing means for allowing a both-eye viewing window for symmetrically looking at said virtual image generated from said image source.

5. The portable electronic device of claim 1 wherein:
said real image means further includes a set of real image lenses for generating a real image from said image source.

6. The portable electronic device of claim 1 wherein:
said image source further includes a color sequential light source and a micro-display device for generating an image for said portable electronic device.

7. The portable electronic device of claim 1 wherein:
said virtual image display system having a dimension of approximately three to five inches in height and one to three inches in thickness.

8. A method for configuring a image display for a portable electronic device comprising:
employing a real image means for generating a real image of an image source; and
employing a virtual image means for generating a magnified virtual image of said real image.

9. The method of claim 8 further comprising a step of:
configuring said virtual image means as a foldable virtual image display system for folding said virtual image display for reducing a thickness of said portable electronic device.

10. The method of claim 8 wherein:
said method of configuring said virtual image means further comprising a step of employing a beam splitter and a concave reflector for generating said virtual image of said real image.

11. The method of claim 8 further comprising a step of:
employing a viewing means for allowing a both-eye viewing window for symmetrically looking at said virtual image generated from said image source.

12. The method of claim 8 wherein:
step of employing said real image means further includes a step of employing a set of real image lenses for generating a real image from said image source.

13. The method of claim 8 further comprising a step of:
employing a sequential color image source and a micro-display device for generating an image for projecting to said real image means for generating said real image.

14. The method of claim 8 further comprising a step of:
configuring said image display with a dimension of approximately three to five inches in height and one to three inches in thickness.

15. An image display system comprising:
an image source for projecting a source image;
a real image means for receiving said source image and generating a real image for said source image; and
a virtual image means for receiving said real image for generating a magnified virtual image of said real image.

16. The image display system of claim 15 further comprising:
a light source for projecting a light onto said image source.

17. The image display system of claim 15 wherein:
said image source further includes a liquid crystal on silicon (LCOS) monochrome panel.

18. The image display system of claim 16 wherein:
said light source is a color sequential light source.

19. The image display system of claim 16 wherein:
said light source is a light emitting diode (LED) with color LED elements for emitting red, green and blue (RGB) lights.
